(19) United States
(12) Patent Application Publication
(10) Pub. No.: US 2012/0116794 A1
(43) Pub. Date: May 10, 2012

(54) MEDICAL ADVICE CARD HAVING AUDIO RECORDING

(75) Inventor: Sharon R. Wilkerson-Amendell, Kansas City, MO (US)

(73) Assignee: THE CHILDREN'S MERCY HOSPITAL, Kansas City, MO (US)

(21) Appl. No.: 13/102,841

(22) Filed: May 6, 2011

Related U.S. Application Data
(60) Provisional application No. 61/332,190, filed on May 6, 2010.

(51) Int. Cl. G06Q 50/22

(52) U.S. Cl. 705/2

(57) ABSTRACT

The present invention is related to a medical advice card and label containing an embedded audio chip or card. The embedded audio chip or card plays information related to a health care treatment plan in order to improve compliance with physician instructions. The medical advice card or label may also contain written information relating to the audible information related to a health care treatment plan.

### RELATED APPLICATIONS

This application relates to and claims priority to U.S. Provisional Patent Application No. 61/332,190, filed May 6, 2010, which is hereby incorporated by reference in its entirety. Both applications are commonly owned.

### BACKGROUND

Clear communication between health care providers and the families they serve is central to effective health care. The written word continues to be the dominant format for giving guidance to patients and their caretakers, despite increasing evidence that low health literacy is a major barrier throughout our communities.

### Low Health Literacy

Health literacy is the degree to which individuals have the capacity to obtain, process, and understand basic health information and services needed to make appropriate health decisions. It includes reading, listening, analytical ability, and decision-making skills. Low health literacy has been linked to poor health outcomes and lack of knowledge about one's own health, especially regarding chronic illnesses. Most studies addressing this problem have focused on a patient's or parent's ability to read, although reading skill is only one aspect of literacy. To overcome lack of reading ability, interventions to improve patients' understanding of health and health behaviors have included pictures or videos that supplement or replace written information.

### Anxiety

In addition to problems related to literacy, another challenge to treatment plan adherence arises from the anxiety often associated with a significant medical event in a patient's life, especially when the patient is a child. For example, asthma can be a life-threatening ailment. This fact rarely goes unnoticed by a parent when the physician describes the diagnosis and explains the treatment plan the family will be asked to follow. As anxiety goes up, attention to and retention of the treatment plan typically goes down. For this reason, the medical community routinely searches for and tests reasonable new techniques that would enrich the relevance and utility of the treatment plan for the family, thus heightening commitment to it and heightening the opportunity for better medical outcomes as a result.

### Asthma

Asthma is a chronic respiratory illness affecting an estimated 22 million individuals in the US, 6 million of them children. Annual direct costs of asthma in the US are approximately $32 billion. Asthma is characterized by nagging daily symptoms such as cough and breathing difficulty with exertion, and by attacks of more severe respiratory difficulty that can require urgent medical care. The limitations these symptoms and attacks place on asthmatics' lives are substantial, leading to generally lower quality of life. Successfully controlling symptoms and attacks frequently involves daily medications and requires the confident understanding of a sometimes complicated treatment plan. A set of care standards has evolved around the control of symptoms and the treatment of asthma attacks, making patient instruction relatively predictable in regard to information and guidance.

One of the biggest challenges faced by health care providers is how to convey information about a particular health care plan in an understandable way, in a format that can be easily recalled in the home setting when asthma symptoms change. To date, the most widely used method involves the creation of a written asthma action plan (AAP), which organizes information into three zones (green—no symptoms, yellow—mild or moderate difficulty, red—severe difficulty), each with its own instructions. Though conceptually, the AAP can be easy to grasp, the details can be difficult to follow and remember, especially when it appears only in written form.

### Compliance

Compliance is a behavioral process that helps maintain and improve health, and manage symptoms and signs of disease, and is strongly influenced by the environments in which patients live, in which health care providers practice, and in which health care systems deliver care. Assuming health care providers make appropriate recommendations, and patients have the knowledge, motivation, skills and resources to follow the recommendations, patients will get well or stay well with the correct following of medical advice, whether taking the right drugs on time and in the proper doses, using appliances or devices, attending courses of therapy, or adhering to appointment schedules.

Noncompliance is a universal and difficult-to-address issue in health care. For various and complex reasons, patients often do not follow or even resist the advice of health care providers and thereby neglect what is in their best interest. Though only 50% of patients follow treatment recommendations, the problem is system-related rather than solely the patient's problem and solutions must emanate from the provider side of health care.

The degree to which patients comply with medical instructions directly impacts their welfare. How well patients ‘do what the doctor orders’ affects the efficacy of treatments, rates of recovery and incidence of re-admissions. Even though patients understand that when they follow instructions, they'll feel better sooner and their recoveries will last longer, noncompliance is epidemic. Physicians are frustrated because outcomes are compromised; patients are ashamed of not taking more responsibility for their health; and insurance companies and the economy are absorbing higher medical costs than they would if compliance rates were higher. About half of the two billion prescriptions filled each year are not taken correctly. One-third of patients take all of their medicine; one-third take some medicine; one-third of prescriptions are never filled.

Noncompliance is as dangerous and costly as many illnesses, causing 125,000 deaths annually in the U.S. and leading to ten percent of hospital admissions, which costs $15.2 billion among 3.5 million patients.

The incidence and implications of noncompliance may be more pronounced within pediatric health care: children often are too young to understand fully the consequences of noncompliance, too young to self-manage, and must rely on parents or guardians whose ability to comply on behalf of children may be mitigated by compliance issues of their own.

The goal of compliance is to help patients practice good self-care when they leave the hospital or clinic and resume their day-to-day lives. In today's more patient-centric environment, getting patients to accept their medical treatments and self-manage requires a different way of thinking about compliance.

‘Compliance’ implies an involuntary act of submission to authority in which the patient ‘surrenders’ to the medical model. The focus is about proving the doctor right and the patient wrong, an outdated doctor-centric approach that disrespects the patient and doesn't always lead to the best health outcomes.

‘Adherence,’ a patient-centric approach, honors the patient role in planning their health care and encourages them to take responsibility for their own health, which patients experience as self-managing and voluntary.

‘Compliance’ as terminology is now un-PC, as it assumes Doctor Knows Best. The contemporary vernacular that respects patient accountability is ‘Adherence.’

Noncompliance was regarded as a health care professional's term for disobedience, lack of will or irrational behavior. However, contemporary theories about adherence indicate resistance is driven by various factors relating to the medication, the patient, the health professional and the health system, including, in presumed order of incidence:
Forgetfulness
Prescription not dispensed
Purpose of treatment not clear/not convinced treatment is needed
Perceived lack of improvement
Real or perceived adverse effects
Instructions for administration not clear
Physical difficulty in complying (e.g. opening medicine containers, handling small tablets, swallowing difficulties, travel to place of treatment)
Unattractive formulation, such as unpleasant taste
Complicated regimen
Economic issues/cost of drugs
Hopelessness about recovery

Although many studies report the effects of different strategies in improving adherence—including reducing the frequency of administration and reducing the numbers of medicines a patient has to take—there is no evidence that such measures are effective. Interventions can work, as long as they fit within the context of patients' lives and address individual sets of pros and cons that influence behavior. A provider-based adherence program involves the quality of interaction between the patient and provider: a) the provider's understanding of the patient's health beliefs and attitudes, as well as social and psychological factors thought to influence adherence; b) the provider's communication skills in giving information and motivating adherence; and c) the patient's ability to understand the illness and the treatment, including the duration and complexity of the regimen. A telephone-based adherence program involves telephone counseling prompted by software that can address the non-adherence issues of not filling prescriptions, not understanding purpose of treatment, doubts whether the medicine is working, stopping the medication, side effects, unclear instructions and physical difficulties. Interviewers are prompted through the process of probing for information and providing appropriate responses to patient questions. A web-based adherence program involves monitoring software that provides a continuous link between patients in their homes and their health care providers, enables patients to input data, access medical information and protocols, and receive reminders or changes in protocol; and enables providers to monitor dosages, dates and times via bar code readers and weight scales. Web-based adherence programs are typically used in disease management programs to impact compliance with interventions. Pharma-based interventions are consultancies that help pharma stimulate brand growth via a) educating physicians on the latest treatment options, b) encouraging patient compliance (refill reminders, progress tracking, scheduling follow-up doctor visits, disease information), and c) connecting physicians and patients with pharmacies that fulfill treatment needs. The focus is on pharma versus the patient, e.g., recovering manufacturer and pharmacy sales lost to noncompliance, growing pharma share and improving patient retention. Gadget-based adherence programs address forgetfulness, the most common reason for non-adherence, and simplify complicated regimens via organizers, dispensers and reminders. Examples of gadget based programs include:

Pill identifiers—prevents medication errors and simplifies complicated regimens via pill organizers and pill boxes
Automatic dispensers—ensures meds are taken properly and on time, and simplifies complicated regimens via reminder/dispensing systems
Alarms and vibrating watches/pagers—ensures on-time doses via multiple reminders across the day

What is needed in the art is a convenient and informative way to provide patient care instructions to ensure compliance and adherence with medical advice and avoid the problems associated with low health literacy, anxiety, and non-compliance or non-adherence.

### SUMMARY OF THE INVENTION

The present invention overcomes the deficiencies of the prior art and provides for a medical advice device incorporating an audio card comprising an audio recording, giving a patient medical care instructions, and methods of use. In preferred embodiment, the medical advice device is a label or card. The advent of low-cost, re-playable audio recording chips or audio cards introduces the possibility of sending patients home with spoken information in hand, overcoming the common communication barrier posed by low reading ability and the poor understanding of health information it can cause.

In one aspect of the present invention, a medical advice device is provided. The medical advice device preferably comprises a material, wherein a recordable audio chip or card is embedded within the material. There is preferably a switch or trigger on the audio card, where the switch or trigger is operable to move between an open and closed position. Preferably, the switch is in an open position when the audio chip or card is not activated and the switch is in a closed position when the audio chip or card is activated. The audible information on the audio chip or card is related to a health care plan.

In another aspect of the present invention, a label for a container incorporating a recordable audio chip or card is provided. The label preferably has an adhesive on one side giving the label the ability to adhere to a container such that the label can be mounted on the container. Preferably, the label is mounted around the surface of the container. In a preferred embodiment, the label contains a flap. The flap may contain a mechanism to removably attach a corner or edge of the flap back onto the label or container. Examples of such mechanisms include, but are not limited to, Velcro, removable adhesive, magnets, a slit or pocket into which the corner of the edge could be inserted, and the like. The flap preferably allows a greater surface area for written information. The recordable audio chip or card can be located anywhere, but is preferably embedded between a first face and an opposing second face of the label. A tab attached to the label includes a connector operable as a switch or trigger such that the audible information is played from the audio chip or card when the tab or a portion thereof contacts or completes a circuit and powers or activates the audio chip or card. This tab is preferably activated when the flap is pulled away from the container. The audio chip or card preferably contains audible information relating to medical advice having to do with what is present in the container to which the label is affixed.

In another aspect of the present invention, a label for a medical device is provided for. Preferably the label has an embedded audio chip or card between the first face and opposing second face of the label. The label, as described above, preferably has a removable and reusable adhesive on one side giving the label the ability to adhere to the medical device multiple times. Written health care instructions are preferably printed on the surface area of the label and the embedded audio chip contains audible information relating to the medical device.

In a further aspect of the present invention, a medical advice card incorporating a recordable audio chip or card is provided. The medical advice card preferably comprises a material that is folded in half, thereby creating two outer faces and two inner faces of the card, wherein the two outer faces oppose the two inner faces. The audio chip or card is preferably embedded between one of the outer faces and one of the inner faces of the card. The audio chip or card is preferably activated when the folded card is unfolded or open by way of a switch or trigger that is engaged when the card is unfolded or opened. The switch or trigger preferably closes a circuit which activates the audio card. Preferably, the card has written information on the surface of the card that is related to the audible information recorded on the audio chip or card.

An additional aspect of the present invention provides for a method for increasing compliance with or adherence to a medical treatment plan. The method comprises the steps of recording audible information related to a medical treatment plan onto an audio chip where the audio chip is secured to the medical advice label or medical advice card, and providing the label or card to a patient or caregiver in need thereof. The medical advice label or medical advice card is preferably the label and card provided by the present invention.

A method of communicating with a patient or caregiver after leaving a health care setting is provided as another aspect of the present invention. The method comprises the steps of recording audible information related to a medical treatment plan onto an audio chip where the audio chip is secured to the medical advice label or medical advice card, and providing the label or card to a patient or caregiver in need thereof. The medical advice label or medical advice card is preferably the label and card provided by the present invention.

A method of communicating instructions for using a medical device to a patient or caregiver is also provided. The method comprises the steps of recording audible information related to the use of a medical device on an audio chip, wherein the audio chip is contained within a label, attaching the label to a medical device, and providing the medical device with the attached label to a patient or caregiver in need thereof. Preferably, the medical advice label is that provided by the present invention.

Any recordable audio chip will work for purposes of the present invention. In a preferred embodiment, the audio chip for placement in the medical advice audio card is similar to that as disclosed in US 2009/0259474, filed on Apr. 11, 2008, the contents and teachings of which are incorporated herein.

In another aspect of the present invention, a card or label in accordance with the present invention comprises an audio card or chip with at least one, more preferably, at least two talking chips embedded within. Further, the audio card or label for purposes of the present invention may have one, two, three, four, or five talking chips embedded within. Each of these chips may contain a different part of medical advice and/or may be recorded by a different person. In a preferred embodiment, the first chip is recorded by a person directing the health care plan to which the health care advice pertains. The health care information can be recorded by, but is not limited to, an attending physician, a physician's assistant, a nurse practitioner, a nurse, a dentist, an optometrist, a pharmacist, or any other related health care worker. The second chip preferably contains information related to the general condition being treated, time for next appointment, or instructions for administration of medication at school, however, this list is not meant to be limiting. Additionally, multiple chips may be recorded in different languages so that the information can be understood by people taking part in the patient's care, even if they do not use the same primary language.

The audible information can be any information related to, but not limited to, a health care topic, a patient-specific health care plan, specific instructions for using a product present in the container, dosage instructions for a medicine dispensing device, time and date of next appointment, information related to the general condition being treated, and combinations thereof. The audible information can be in any language appropriate for the person using the present invention. This aspect of the present invention is especially useful when a person using the present invention, preferably a patient, does not speak English.

The audible information, in a preferred embodiment, follows a protocol to assure consistency of points from patient to patient. The audible information is enriched by the authority of a health care professional's own voice, by the novel familiarity of that health care professional with the patient's name, possibly some specific interests that can be pursued in good health through adherence to a treatment plan, and by the personal invitation of the health care professional to stay in touch with the clinic or the doctor in the event that there is a need for further support.

The medical advice label or medical advice card preferably contains written information related to the audible information on the audio chip or card. This information preferably relates to a patient specific health care plan, instructions for administering medication, instructions for how to take at home medical tests, information regarding a specific condition or diagnosis, date and time of next appointment, instructions for use at school, what types of adverse reactions should be noted and how they should be handled, and combinations thereof. Any health care information related to the container or medical device would be appropriate for the label.

The container for use with the label of the present invention preferably contains a medical product. Any medical product contained within a container will work for purposes of the present invention. Preferably, the container holds any of the following, but is not limited to: medication, testing supplies, pills, inhalers, liquid medication, chewable medication, bandages, vitamins, injectable formulations, medical supplies, and combinations thereof. The label of the present invention can also be placed on any type of medical device. Medical devices suitable for purposes of the present invention include, but are not limited to, inhalers, blood sugar monitors, chemotherapy drug dispensing devices, walkers, wheel chairs, slings, bandages, nebulizers, medication dispensing devices, and the like.

In families where literacy is an issue, the label or card's message is informative enough to keep the family focused on the basics, and entertaining enough to relieve inhibitions and anxiety that might otherwise prevent the family from reaching out for help. In families where literacy is not an issue, as the anxiety associated with what is oftentimes seen as a traumatic medical event, the card offers messages of reassurance, reminding the family that adherence to the treatment plan is what gives your child the patient the greatest chance to live a long and healthy life and recover from or effectively manage the disease or condition.

In an embodiment with two talking chips, the first chip is prerecorded with instructions or information related to the treatment plan and the second chip is prerecorded with secondary information. This secondary information can be, but is not limited to, side effects, things to watch for, a message about the importance of the plan or instructions, or any other helpful information. This message would reinforce the manageability of a specific disease or condition, such as asthma, while reminding parents that failure to do so can imperil the safety and health of the patient. Preferred message will be informative yet engaging, reassuring yet firm, and they should be designed to underscore the value of the treatment plan and the responsibility of parents as partners in the caregiving process

The use of the medical advice audio device improves patient compliance or adherence by at least 10%, more preferably, by at least 20%, still more preferably, by at least 30%, more preferably, by at least 40%, more preferably, by at least 50%, still more preferably, by at least 60%, even more preferably, by at least 70%, more preferably, by at least 80%, most preferably, by at least 90%, and when compared to those patients not using the medical advice audio device of the present invention.

The medical advice audio device according to the present invention can be used for any patient receiving medical care that will continue outside of a professional healthcare setting. The medical advice audio device can be used in connection with surgery, treatment of diseases and cancers, physical therapy, occupational therapy, administration of medication, wound care, treatment of illness, preventative care, among many others. Infants, children, adults, and the elderly will benefit from the use of the audio portion of the medical advice audio device. In a preferred embodiment, the medical advice audio device is used in connection with the treatment of asthma, but the use of the medical advice audio device is not limited to asthma.

The recipient of the medical advice audio device is a patient of that clinician or of that clinician's hospital or practice, the patient's school, or the parent or other caretaker of such a patient. The personalized recorded information is, at least in part, the clinician's message to the patient, where the content of the medical information is determined, at least in part, by the patients medical history or by observations and tests in an immediately preceding examination of the patent by the clinician or by the clinician's medical and laboratory associates. The personalized recorded information gives the patient, or the patient's caregiver, or both, medical guidance or information relevant to the disease condition for which the clinician is treating the patient (“medical information”), including:

what actions the clinician desires the patient or caregiver to take or avoid;

related information that might help the patient understand the disease; and

statements stressing the importance of adhering to the medical regime prescribed by the clinician and presented as part of the recorded message, in the second element of the personalized medical advice audio card, or in an extraneous format such as during the patients visit to the clinician.

In a preferred embodiment, the medical advice audio device also includes as a second element, on one or more of its printable surfaces, medical information in a written, graphical, or other visual form (“medical chart”), where the medical chart could include one or more of:

A single set of the clinician's written instructions;

A multi-element set of the clinician's written instructions, possibly formatted to emphasize that the various elements applied respectively to different future dates or days of the week, different observed conditions of the patient, different observed environmental factors, specified alternative contingencies to be confirmed with the clinician in e.g. a telephone call or email exchange, etc;

A section that is labeled in a way relevant to the patient and into which the patient, or the patient's caregiver, is to record in words and statements pertaining to the section label (progress of symptoms, adherence to prescribed regimen, observations, etc.);

A segment of “graph paper” or the like, in which the axes are labeled and onto which the clinician, by hand or through some printing device, has marked data points or lines relevant to the patient (e.g. historical or expected change in patient's temperature, weight, blood pressure, etc.); and

A segment of “graph paper” or the like, on which the axes are labeled and onto which the patient or the patient's caregiver is requested to mark data or observations relevant to the patient (dosage taken vs. day of week, severity of observable symptoms vs. time, etc.).

The present invention can be used as a convenient medium in which a clinician could record medical information or instructions; especially useful for young children who can not read, or for adult caregivers who have difficulty reading, since some of the medical information would be in an audio format. The invention is also useful for “localizing” the medical information to a variety of languages.

The present invention is a useful tool for addressing adherence issues, namely, time constraints of physicians, highly-charged emotions, language barriers and illiteracy. Time constraints of physicians may prevent them from ensuring families understand the purpose of the treatment and how to carry out instructions; the art and discipline of customizing an adherence card would convey information in a more thorough and deliberate fashion, enabling the family to then re-play instructions as many times as necessary until the instructions are internalized. Highly-charged emotions during treatment or hospitalization may prevent families from absorbing and following through on important treatment recommendations; perusing physician instructions in the security of one's home would feel less intimidating and increase the likelihood of comprehension and follow-through. Language barriers or illiteracy may prevent families from comprehending and complying with instructions, and translators' messages may be misunderstood by patient families during emotionally-charged briefings with the attending physician, the translator and the family; production protocols would a) facilitate translations in languages suiting a wide variety of foreign languages and ethnicities, and b) ensure the accuracy of those translations.

For purposes of the medical advice audio device of the present invention, physicians record audio instructions onto at least one, more preferably, at least two chips. Preferably, each chip has a capacity of six to 150 seconds in length, although longer capacities are possible. In a preferred embodiment, one chip contains a generic overview or introduction of the technology, instructions on how to use the card; and another chip contains specific medical instructions, depending upon specific needs.

Each chip is programmed to contain only one indelible message that cannot be recorded over, thus preventing kids or even adults from playing with the cards after they leave the physician's hands and creating liability problems, particularly if the device is represented as containing instructions/advice/prescriptive recommendations authored and offered by a medical doctor.

Preferably, two types of audio chips are used for purposes of the present invention, a customized chip or a programmed chip. The customized chip contains personalized instructions applicable to medications and/or devices for the family whose child is being discharged from the hospital or under the care of one of the outpatient clinics or doctors offices. The programmed chip contains, in addition to customized aftercare instructions, another series of chips that contain pre-recorded messages about well baby care, colds, immunizations, virus and flu outbreaks, as well as other health-related events affecting the community.

In addition to enhancing patient satisfaction, a customized medical advice audio device serves a hospital or medical institution by improving clinical outcomes and advancing market presence. Better clinical outcomes reduce health care costs via reduced interventions which, when demonstrated to insurance providers, conceivably could qualify the device's ‘manufacturing’ and ‘distribution’ expenses as reimbursable because they would be part of a treatment plan. Additionally, reduced interventions will save time as well as money. Fewer interventions make more physician time available, which in turn reduce wait times and alleviate capacity issues.

Upon recognizing the card's ability to improve outcomes while reducing costs, insurance providers will in turn require more widespread use, and demand will grow exponentially, making the adherence card an eventual ‘de rigueur’ in the effective practice of medicine.

Preferably, the medical advice audio device of the present invention helps parents do a better job of complying (adhering) to the physician's prescriptions, thus, the insurance company's risks are reduced because better outcomes are achieved, and the expense of intervention required by a family's failure to adhere to a physician's recommendations is eliminated.

### BRIEF DESCRIPTION OF THE DRAWINGS

FIG. 1: a view of the medical advice audio card where the card is open or unfolded and contains written material on one of its inner faces;

FIG. 2: a view of the medical advice label on a container where the tab of the label is engaged and where the label contains written material on its outer face;

FIG. 3: a view of the medical advice audio card where the card does not contain written material; and

FIG. 4: a view of the advice label on a container where the label does not contain written material.

### DEFINITIONS

“Audio card” or “audio chip”, as used herein, refers to an external audio interface that uses software to generate sound.

“Health care information”, for purposes of the present invention, refers to any information that is related to the care of a patient. Examples include, but are not limited to, information relating to administration of medication, the use of a medical device, home care after a hospital stay or physician visit, a particular condition, a particular disease, a particular symptom or set of symptoms, and combinations thereof.

“Health care professional”, as used herein, refers to any person in the medical field qualified to recite health care information onto a recordable audio card, including, but not limited to, a physician, physician's assistant, nurse practitioner, nurse, dentist, pharmacist, optometrist, and technicians relating thereto.

“Medical device” as referred to herein includes anything useful in medical care. Examples include, but are not limited to, wheelchairs, walkers, inhalers, testing kits, band aids, bandages, wound care, heating pads, blood sugar testing supplies, chemotherapy drug administrators, medical dispensing devices, glasses, contacts, splints, casts, slings, helmets, oxygen administering devices, nebulizers, and combinations thereof.

“Container” refers to, but is not limited to, any article that has the capacity to contain something within its boundaries. Preferably, the container holds something that must be administered in the course of a health care treatment plan.

“Label”, as referred to herein, includes any material which can be attached to a container or device using an adhesive. Preferably, the label is made from paper and has an adhesive on one side suitable for attaching to a container or medical device. In an alternately preferred embodiment, the label has a tab suitable for written material, which extends from the container or medical device and which can contain further information.

For purposes of the present invention, “compliance” and “adherence” are used interchangeably and the meaning of both words is the same.

“Medical treatment plan” or “health care plan”, as used herein, refer to a plan of care put in place by a physician or other health care profession. The plan may include, but is not limited to, the administration of medication, the use of a medical device, instructions for therapy exercises, instructions regarding management of symptoms, instructions on appropriate behaviors, information about side effects, instructions on how to evaluate a condition, and combinations thereof. For purposes of the present invention, “medical treatment plan” and “health care plan” can be used interchangeably.

For purposes of the present invention, “trigger” and “switch” are used interchangeably and refer to the same mechanism.

“Audio chip” and “audio card” are used interchangeably in the present application and refer to the same device.

### DETAILED DESCRIPTION

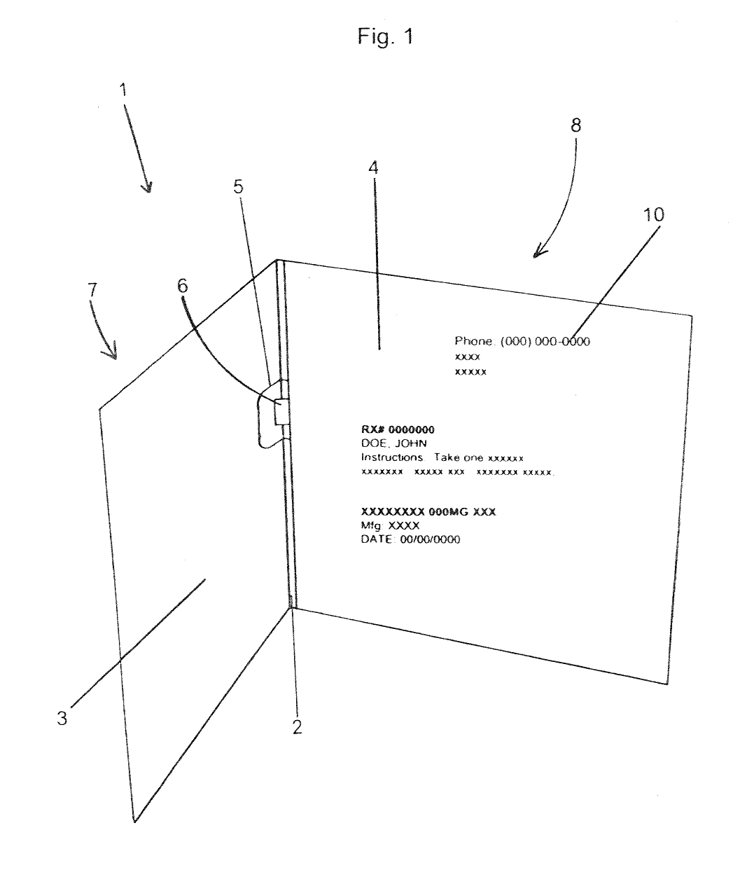

The present invention provides for a medical advice card 1 comprising a material with a fold 2 in the center (FIG. 1). The medical advice card 1 preferably has a first inner face 3 and a second inner face 4, as well as a first outer face 7 that is on the front of the card and a second outer face 8 that is on the back of the card. The two inner faces 3, 4 oppose the two outer faces 7, 8. Preferably, the inside of the folded card has a first face 3 and a second face 4. Preferably, an audio chip (or audio device) is connected to a carrier 5. The carrier is preferably at least partially located or embedded underneath the second inner face 4 of the card, in-between the second inner face 4 and the second outer face 8. A switch 6 is attached to the carrier 5, such that when the folded card is unfolded or opened, an audio message will begin to play. Preferably, the switch 6 is operable to move between an open position in which the card is closed and audio chip is not activated and a closed position in which the card is open and the audio chip is activated. The first outer face 7 of the card 1 preferably displays information relating to the medical advice card 1, such as the patients name, the hospital or clinic the patient was seen in, the health condition being treated, the medical device being used, etc. Preferably, the second inner face 4 of the card 1 contains written information 10 relating to the audio information which can be heard from the audio device upon unfolding or opening the medical advice card 1.

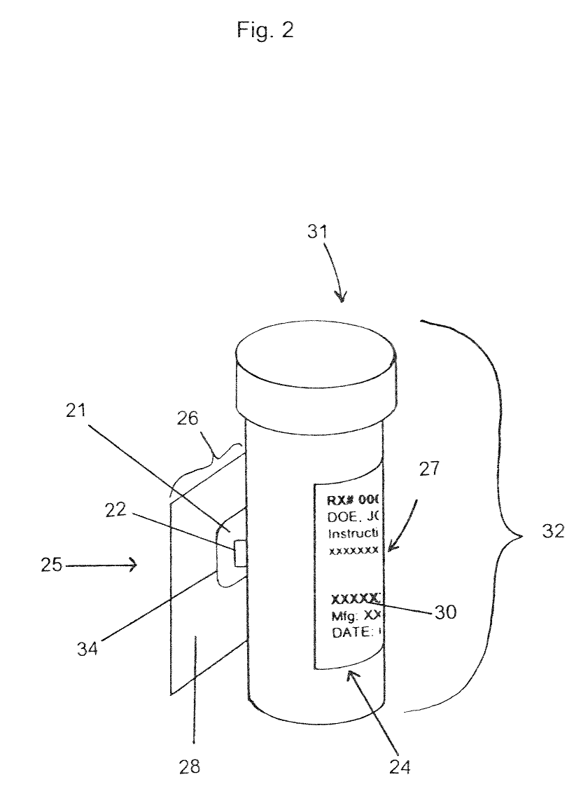

The present invention also provides for a label 25 which can be attached to a container 20 or a medical device (FIG. 2). The container preferably includes a body 32 that is capable of surrounding something in order to contain it and a lid 31 for keeping something within the container 20. The label preferably has a first face 27 and a second face 28, which is on the back side of the first face 27. Preferably, at least a portion of the second face 28 of the label 25 has an adhesive 24 on it such that a portion of the second face 28 adheres to the surface area of the container 20. Preferably, the label 25 has a flap 26 extending away from the container 20 or medical device or is of sufficient length to extend over a portion of first face 27. This flap 26 exposes the second face 28 of the label 25 as well as the surface to which it is adhered, which could be the container or first face 27. A carrier 21 is preferably attached to an audio device embedded or located in the label such that when the flap 26 is extended a tab 22 attached to a switch moves or slides a contact into alignment with a circuit, thereby closing the circuit and activating the audio device such that audible information is heard from the label 25 through the audio device. Preferably, the switch is operable to move between an open position in which the audio chip is not activated and a closed position in which the audio device is activated. This can be accomplished by the sliding of the tab as described above. In one embodiment, the label 25 has a fold 23, such that unfolding the label 25 pulls the tab 22 away from the container 20 in such a way that the switch closing the circuit is engaged and audible information on the audio device or chip can be heard by the user. The label as depicted in FIG. 2 can also be used on a medical device as defined by the present invention.

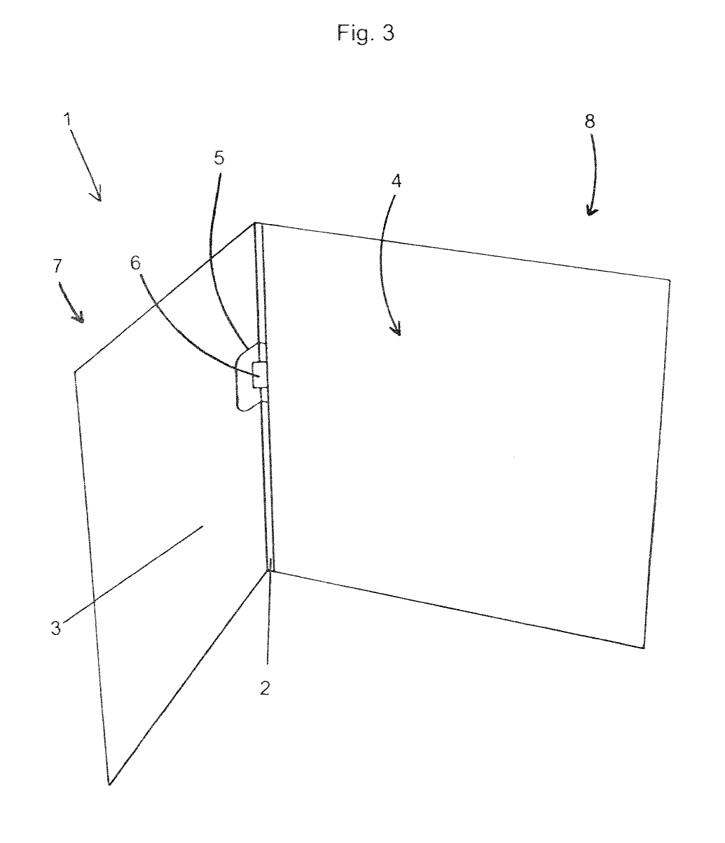

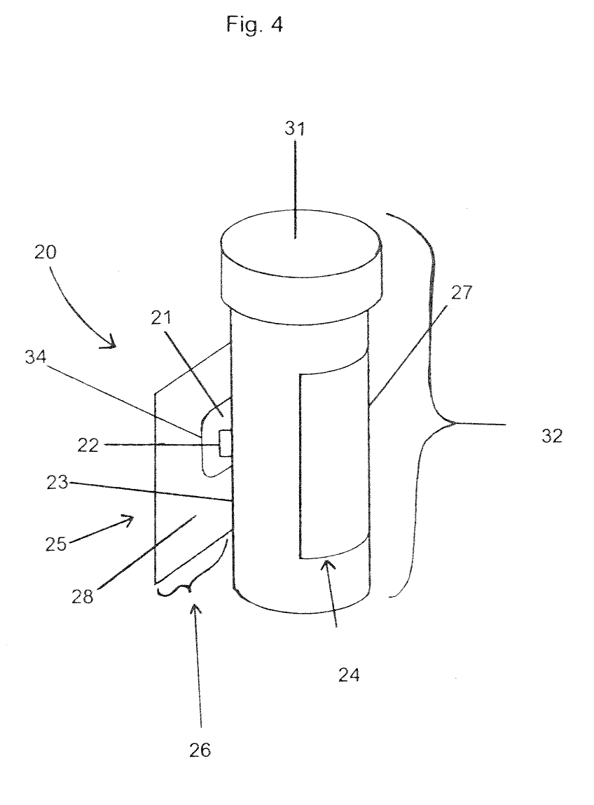

FIG. 3 illustrates an embodiment of the medical advice audio card 1 that does not contain written material on the face of the card. FIG. 4 illustrates an embodiment of the medical advice label 21 that does not contain written material on the face of the label.

A method for increasing compliance with or adherence to a medical treatment plan is provided. The method comprises the steps of recording audible information related to a medical treatment plan onto an audio device or chip, where the audio chip or device is secured to the medical advice label 25 or medical advice card 1, and providing the label 25 or card 1 to a patient or caregiver in need thereof.

The present invention provides for a method of communicating with a patient or caregiver after leaving a health care setting. The method comprises the steps of recording audible information related to a medical treatment plan onto an audio chip or device where the audio device or chip is secured to the medical advice label 25 or medical advice card 1, and providing the label 25 or card 1 to a patient or caregiver in need thereof.

A method of communicating instructions for using a medical device to a patient or caregiver is also provided. The method comprises the steps of recording audible information related to the use of a medical device on an audio chip or device, wherein the audio device or chip is contained within a label 25, attaching the label 25 to a medical device, and providing the medical device with the attached label 25 to a patient or caregiver in need thereof.

### Example 1

This example was designed to answer 3 specific research questions in order to assess the present invention. The 3 research questions were:
1) Can control of a child's asthma symptoms be improved through the distribution of a recorded asthma instruction card at the health provider's office?
2) Will primary caregivers of asthmatic children aged 5 to 13 years receiving a recorded asthma instruction card at the health provider's office be more activated in the care of their children's asthma than those receiving usual care?
3) Will primary caregivers of asthmatic children aged 5 to 13 years be satisfied with the distribution and use of a recordable asthma instruction card?
   Specific aims of this example are:
1) To compare the mean difference in Asthma Control Test (ACT) scores for asthmatic children aged 5 to 13 years before and one month after receiving a recorded asthma instruction card to the mean difference in ACT scores for those receiving usual care.
2) To compare the mean difference in Patient Activation Measure (PAM) scores for primary caregivers of asthmatic children aged 5 to 13 before and one month after receiving a recorded asthma instruction card to the mean difference in PAM scores for primary caregivers of those receiving usual care.
3) To measure the satisfaction of primary caregivers receiving a recordable asthma instruction card through quantitative and qualitative survey questions.

### Study Design

This study will be a randomized controlled trial evaluating measures of asthma control and primary caregiver activation and satisfaction associated with a novel asthma education intervention: a recorded asthma instruction card given by a health care provider during an office visit.

### Study Subjects

Subjects will include asthmatic children seeing a physician for their asthma care. To qualify for inclusion in the study, the children must be 5 to 13 years old, have asthma (as determined by diagnostic code), and have been seen at a Pediatric Care Center during the last 12 months. They also must have asthma that is uncontrolled (as determined by a screening survey), since improvement in asthma symptoms would not be realistic among asthmatics who are already well-treated. Any child with a chronic respiratory problem in addition to asthma will be excluded from consideration, as this kind of comorbidity could bias the outcome of their asthma control.

### Methods

### Recruitment of Subjects

After creating a candidate list of all currently enrolled FHP patients aged 5 to 13 years having an asthma diagnosis in the last twelve months, 26 candidates will be randomly selected for initial screening by telephone. A research assistant will call the primary caregiver, explain the study, and request permission to perform the screening procedure, which consists of administering the Asthma Control Test (ACT), an 8-question survey that measures a child's asthma control over the last four weeks. If the score is less than 19 (uncontrolled asthma), the primary caregiver will be invited to participate in the study. If they accept, an appointment will be made to see one of the study providers. If they refuse, another family will be selected at random from the initial candidate list. As the families accept participation, they will be assigned at random to either the intervention group or the control group. Families will be recruited until a total of 26 have accepted, 13 assigned to each study group. The assignments will not be known to the families.

### Baseline Visit

At the scheduled time, each primary caregiver will meet at a Pediatric Care Center (PCC) with the study coordinator to give written, informed consent for participation in the study. The ACT will be re-administered to assure that the child's asthma continues to be less than 19 (uncontrolled). After consent is obtained and ACT confirmed, the baseline Patient Activation Measure (PAM) will be administered by the study coordinator. The family will then meet with the study provider to have a full asthma check-up and receive either the intervention (written AAP+recordable card) or usual care (written AAP). The one-month follow-up visit will be scheduled with the same study provider before the family leaves the clinic.

### Follow-up Visit

One month following the baseline visit, the family will return to the PCC for re-administration of the ACT, the PAM, and another visit with the same study provider. A short survey addressing the primary caregiver's satisfaction with the intervention will be administered, as well.

### Results and Conclusions

### Analysis

The mean differences in ACT for each study group will be compared to answer the question: did asthma control improve more in the recordable group than in the group getting usual care? If there is a significant improvement in asthma control between these two groups of 13 subjects each, the study will be stopped. If not, then 70 more subjects will be recruited and divided equally into intervention and control groups, who will go through the same process as the initial 26. This expansion of the study would allow for a more confident answer to the above question, as a lack of improvement between smaller groups may be due to the small group size alone.

The mean difference in PAM scores will be compared to answer the question: were primary caregivers in the recordable card group more activated in the care of their children's asthma than primary caregivers in the group receiving usual care? The study has not been designed to use this as the primary outcome, but even if a significant difference is not found, the scores of the intervention group alone could be helpful in understanding how the card was received.

Finally, the quantitative and qualitative responses to the satisfaction survey will be analyzed to understand primary caregivers' satisfaction with the recordable card, including its perceived utility, likeability, and effectiveness.

The results will show that patients using the medical advice audio card will have better ACT scores than those patients who did not use the medical advice audio card.

We claim:

1. A medical advice device comprising:
a. a material having a first end and a second opposing end, a first face and an opposing second face;
b. a recordable audio chip between said first face and said second opposing face;
c. a switch operable to move between an open position in which said audio chip is not activated and a closed position in which said audio chip is activated;
d. written information on at least one of said first and second faces of said label; and
e. audible information on said audio card; wherein said written information and audible information are related to health care.

2. The medical advice device of claim 1, wherein said written information or said audible information related to health care is selected from the group consisting of information related to pharmaceutical administration, information related to a specific condition, information related to a medical device, information related to a patients next appointment, and combinations thereof.

3. The medical advice device of claim 1, further comprising a flap secured to one of said first or second opposing ends, wherein said flap is foldable over at least a portion of said second face.

4. The medical advice device of claim 3, wherein folding said flap over at least a portion of said second face moves said switch to an open position and unfolding said flap moves said switch to a closed position.

5. The medical advice device of claim 1, further comprising a button or tab attached to said switch.

6. The medical advice device of claim 1, wherein said device is a card or label.

7. The medical advice device of claim 3, wherein said flap is secured to said first end of said material and is removably attachable to said second end of said material.

8. A method of increasing compliance with or adherence to a medical treatment plan comprising the steps of:
a. recording audible information related to a medical treatment plan onto an audio chip, wherein said audio chip is secured to a label or card; and
b. providing said label or card to a patient or caregiver in need thereof.

9. The method of claim 8, wherein said label is the label of claim 6.

10. The method of claim 8, wherein said label is attached to a container for dispensing pharmaceuticals.

11. The method of claim 8, wherein said label is attached to a medical device.

12. The method of claim 8, wherein said label or card further comprises written indicia relating to said audible information related to a medical treatment plan.

13. A method of communicating with a patient or caregiver after leaving a health care setting, comprising:
a. recording audible information related to a medical treatment plan onto an audio chip, wherein said audio chip is contained within a label or card; and
b. providing said label or card to a patient or caregiver in need thereof.

14. The method of claim 13, wherein said audible information is recorded in a language spoken by the patient or caregiver.

15. The method of claim 13, wherein said label is the label of claim 6.

16. The method of claim 13, wherein said label is attached to a container for dispensing pharmaceuticals.

17. The method of claim 13, wherein said label is attached to a medical device.

18. The method of claim 13, wherein said label or card further comprises written indicia relating to said audible information related to a medical treatment plan.

19. A method of communicating instructions for using a medical device to a patient or caregiver, comprising:
a. recording audible information related to use of a medical device onto an audio chip, wherein said audio chip is contained within a label;
b. attaching said label to said medical device; and
c. providing said medical device with said attached label to a patient or caregiver in need thereof.

20. The method of claim 19, wherein said medical device is selected from the group consisting of wheelchairs, walkers, inhalers, testing kits, band aids, bandages, wound care, heating pads, blood sugar testing supplies, chemotherapy drug administrators, medical dispensing devices, glasses, contacts, splints, casts, slings, helmets, oxygen administering devices, nebulizers, and combinations thereof.

21. The method of claim 19, wherein said audible information is recorded in a language spoken by the patient or caregiver.

22. The method of claim 19, wherein said label is the label of claim 6.

23. The method of claim 19, wherein said label is attached to a container for dispensing pharmaceuticals.

24. The method of claim 19, wherein said label further comprises written indicia relating to said audible information related to a medical treatment plan.

25. A medical advice container, comprising the label of claim 6 attached to a container for a pharmaceutical composition, wherein said audible information is related to said pharmaceutical composition.

26. A medical advice device, comprising the label of claim 6 attached to a medical device, wherein said audible information is related to said medical device.

27. The medical advice device of claim 26, wherein said medical device is selected from the group consisting of wheelchairs, walkers, inhalers, testing kits, band aids, bandages, wound care, heating pads, blood sugar testing supplies, chemotherapy drug administrators, medical dispensing devices, glasses, contacts, splints, casts, slings, helmets, oxygen administering devices, nebulizers, and combinations thereof.
